(19) United States
(12) Patent Application Publication
(10) Pub. No.: US 2026/0151783 A1
(43) Pub. Date: Jun. 4, 2026

(54) Disposable liquid container for atomizing device

(71) Applicant: AROMA PERFECTO LLC, Diamond Bar, CA (US)

(72) Inventor: Yong WU, Guangzhou (CN)

(21) Appl. No.: 19/019,563

(22) Filed: Jan. 14, 2025

(30) Foreign Application Priority Data
Dec. 4, 2024 (CN) 202422993507.3

(51) Int. Cl. B05B 7/24

(52) U.S. Cl. CPC B05B 7/2408; B05B 7/2424

(57) ABSTRACT

A disposable liquid container for a atomizing device includes a container with an opening for holding liquid; an atomizing assembly covered the opening, which has a spray outlet, an air inlet, and an atomizing core, and an internal fluid channel for air or liquid flow; a blocking strip which is operable to block the fluid channel. The atomizing assembly is provided with a slot traversing the fluid channel, and the blocking strip is configurated to block communication of the fluid channel, with disposed in the slot and partially extending outside the slot, and unblock communication of the fluid channel, with removed from the slot to restore communication of the fluid channel.

### CROSS REFERENCE TO RELATED APPLICATIONS

The present application claims priority from Chinese Application No. CN 202422993507.3 filed on Dec. 4, 2024, all of which are hereby incorporated herein by reference.

### TECHNICAL FIELD

The present disclosure relates to the field of atomizing devices, and more particularly to a disposable liquid container for an atomizing device.

### BACKGROUND

In the field of atomizer technology, the design and manufacture of liquid containers has always been a core component. For a long time, liquid leakage during transportation and storage has been an important factor limiting the quality of atomizer products. Liquid substances, such as essential oils, medicinal liquids, perfumes, or other functional liquids, are typically contained in the liquid containers, which are prone to leakage when subjected to adverse factors such as external pressure changes, temperature variations, vibration, or impact. Liquid leakage not only leads to product damage and waste but may also cause environmental pollution, and even pose potential threats to consumer health and safety.

In addition, traditional atomizers on the market mainly adopt detachable structures that require users to clean and maintain after use. This not only increases operational complexity for users but may also lead to bacterial growth due to inadequate cleaning or improper maintenance, affecting product hygiene and safety.

Therefore, there is an urgent market need for an atomizer that can solve the leakage problem and feature disposable characteristics. Disposable atomizers offer advantages such as convenient use, no cleaning and maintenance requirements, and prevention of cross-contamination, making them particularly suitable for personal care, home medical care, aromatherapy, and other fields.

### SUMMARY

The present disclosure aims to overcome the abovementioned deficiencies in the prior art by providing a disposable liquid container for an atomizing device, which solves the liquid leakage problem during transportation and storage of the prior art atomizing devices. Additionally, the disposable structure design of the device eliminates cumbersome cleaning and maintenance steps required in the traditional atomizers to improve convenience and hygiene.

The disposable liquid container for an atomizing device according to the present disclosure includes a container with an opening for holding liquid; an atomizing assembly covered the opening, the atomizing assembly having a spray outlet, an air inlet, and an atomizing core, and having an internal fluid channel for air or liquid flow; and further comprising a blocking strip which is operable to block the fluid channel, wherein the atomizing assembly is provided with a slot traversing the fluid channel, the blocking strip is configurated to block communication of the fluid channel, with disposed in the slot and partially extending outside the slot, and unblock communication of the fluid channel, with removed from the slot to restore communication of the fluid channel.

With the configuration of the blocking strip and the slot in the liquid container of the present disclosure, the fluid channel for air or liquid flow can be effectively blocked when the blocking strip is inserted into the fluid channel of the atomizing core, thereby effectively preventing liquid leakage during transportation or storage and ensuring product safety and integrity. The atomizing device obtained according to the present disclosure, including the container, atomizing assembly, and blocking strip, can be entirely designed for single use. This design not only simplifies user operation but also eliminates cumbersome cleaning and maintenance steps required in traditional atomizers. The single-use atomizing core prevents clogging issues that arise from long-term use and need for replacement, thus improving convenience and hygiene. What's more, the disposable structure ensures that each use involves new, uncontaminated components, enhancing usage safety and reliability.

According to the present disclosure, the atomizing assembly has a split design, which can be divided into a first component and a second component, with the slot formed therebetween. This not only facilitates processing and assembly but also, with the slot designed between the first and second components, makes the production installation process of the blocking strip simpler and smoother, thus improving production efficiency. The cooperation between the slot and blocking strip provides a more stable fluid channel blocking effect, thereby further enhancing leakage prevention capability.

Additionally, a sealing member may be further included, which is positioned between at least one of the first component and second component and the blocking strip, corresponding to the fluid channel position. The sealing member surrounds the fluid channel. Such configuration provides an additional sealing layer structure for the connection between the blocking strip and atomizing assembly, ensuring complete closure of the fluid channel when the blocking strip is inserted, thereby preventing liquid leakage through minute gaps between the blocking strip and components. Moreover, it can increase the friction between the blocking strip and atomizing assembly, so that the blocking strip can be more firmly fixed in the slot when in use, which thus prevents accidental detachment during transportation due to vibration or collision, thereby improving product stability and reliability.

According to one preferable embodiment of the present disclosure, the first component may be positioned between the container and the second component, with the sealing member positioned around the fluid channel between the first component and blocking strip. During transportation, liquid from the container cannot leak through minute gaps between the blocking strip and first component. Meanwhile, this enhances friction between the blocking strip and first component, thereby preventing the blocking strip from loosening or detaching due to vibration or impact during transportation or use, which could lead to liquid leakage.

In this case, the sealing member is an elastic sealing ring, and a first cavity is formed in at least one the first component and the second component at a position corresponding to one side of the fluid channel, which is configured for accommodating the elastic sealing ring when the blocking strip is inserted into the slot. The depth of the first cavity is less than the cross-sectional dimension of the elastic sealing ring. When inserted into the slot, the blocking strip compresses the elastic sealing ring within the first cavity, thus generating a pretension force to allow the elastic sealing ring to more tightly adhere between the blocking strip and atomizing assembly, which makes the blocking strip, sealing ring, and atomizing assembly more tightly bonded together, thereby preventing liquid leakage through minute gaps between the blocking strip and atomizing assembly and further improving product sealing performance.

Additionally, a second cavity corresponding to the first cavity may be formed in at least one of the second component and the first component at a position corresponding to another side of the fluid channel. When the blocking strip is pulled out and fluid channel communication is restored, the elastic sealing ring originally compressed in the first cavity will expand due to its elastic properties, and the second cavity provides accommodation space for the expanded elastic sealing ring, so that the elastic sealing ring maintains its correct position, which prevents the expanded elastic sealing ring from dislodging the atomizing assembly or becoming displaced due to a lack of space. Meanwhile, the elastic sealing ring forms a seal at the position left by the removed blocking strip, preventing liquid leakage during subsequent use. Furthermore, the expanded elastic sealing ring blocks the slot, so that the blocking strip cannot be reinserted into the slot, making the device as a truly single-use product and avoiding hygiene issues and performance degradation that could arise from reuse.

According to the present disclosure, the fluid channel particularly includes a liquid channel and an air channel, with the liquid channel connecting the atomizing assembly to an interior of the container, and the air channel connecting the spray outlet to the air inlet.

Furthermore, the liquid channel particularly includes a liquid supply channel and a liquid return channel. The liquid supply channel guides liquid upward from the container to the atomizing core, while the liquid return channel returns liquid downward to the container. In the case that the atomizing core and the container are designed to be respectively positioned on an upper side and a lower side of the slot of the blocking strip when inserted into the slot, the blocking strip is configured to simultaneously block both the liquid supply channel and the liquid return channel. In this configuration, before the blocking strip is pulled out, liquid in the container is prevented from flowing to the atomizing core through the liquid channel due to the blocking of the blocking strip, thereby effectively preventing liquid leakage from the container during transportation or storage.

In this case, the sealing member includes a first sealing element and a second sealing element, with the first sealing element surrounding the liquid supply channel and the second sealing element surrounding the liquid return channel, respectively sealing the liquid supply channel and the liquid return channel. A connecting member may be further included to join the first sealing element and the second sealing element into an integral structure. This enables one-time installation of both sealing elements during product assembly, without the need for separate installation and adjustment, thereby improving production efficiency. Moreover, the integral structure sealing member better maintains its shape and position when the blocking strip is pulled out, thus preventing loosening or deformation caused by blocking strip removal, while also preventing liquid leakage during use.

The present disclosure also provides another structural approach to prevent leakage. The air channel particularly includes an air inlet channel and an air outlet channel, with the air inlet channel connecting the atomizing core to the air inlet, and the air outlet channel connecting the atomizing core to the spray outlet. In the case that when both the atomizing core and the container are positioned on the lower side of the slot or the blocking strip when inserted into the slot, the blocking strip simultaneously blocks both the air inlet channel and the air outlet channel. In such case, before the blocking strip is pulled out, liquid in the container is prevented from flowing into the air channel due to the blocking of the blocking strip.

In this case, the sealing member may include a third sealing element and a fourth sealing element, with the third sealing element surrounding the air inlet channel and the fourth sealing element surrounding the air outlet channel. A connecting member may be further included to join the third sealing element and the fourth sealing element into an integral structure. This enables one-time installation of both sealing elements during product assembly, without the need for separate installation and adjustment, thereby improving production efficiency. Moreover, the integral structure sealing member maintains its shape and position when the blocking strip is pulled out, thereby preventing loosening or deformation caused by blocking strip removal, while also preventing liquid leakage during use.

In the present disclosure, the atomizing assembly and the container may be fixedly connected to form an inseparable integral structure, which can prevent liquid leakage from the interface between the container and the atomizing assembly during transportation or use, while ensuring that the container cannot be disassembled and refilled after the liquid is exhausted, thus achieving true single-use functionality, and avoiding hygiene issues and performance degradation that could arise from reuse.

In order to achieve assembly, the first component includes a first outer flange and an inner body, with the first outer flange extending to the outside of the opening and the inner body extending to the inside of the opening. A first annular groove is formed between the first outer flange and the inner body, with a sealing ring provided within the first annular groove, and the first outer flange is interlocked with the container opening, forming a sealing layer between the container and the atomizing assembly. With such configuration, assembly only requires aligning the first outer flange with the opening of the container and gently pressing down to achieve secure connection. The assembly achieved not only improves overall sealing performance but also further simplifies the assembly process and thus enhancing production installation efficiency.

Alternatively, the second component may include a second outer flange extending to the outside of the opening, with the first component embedded into the second outer flange. A second annular groove cooperated with the container opening is formed between the second outer flange and the first component. A sealing ring is provided within the second annular groove, and the second outer flange is interlocked with the opening of the container. Such configuration forms another type of sealing layer structure between the container and the atomizing assembly. Assembly only requires aligning the second outer flange with the container opening and gently pressing down to achieve secure connection. The assembly achieved not only improves overall sealing performance but also further simplifies the assembly process and thus enhancing production installation efficiency.

Compared to the prior art, through the design of an atomizing assembly including a blocking strip that can be inserted to block the fluid channel, whether blocking the liquid channel or the air channel, it effectively prevents accidental liquid leakage during transportation. This design ensures product safety and integrity before use. Furthermore, sealing members such as elastic sealing rings are provided between the atomizing assembly and the container, as well as between the blocking strip and the fluid channel. These sealing members not only enhance the sealing performance of the entire device to prevent liquid or air leakage, but also improve device stability and durability. Additionally, by firmly connecting the atomizing assembly and the container into an inseparable structure, the overall structural stability and reliability are further enhanced.

The atomizing device obtained according to the present disclosure, including the container, atomizing assembly, and blocking strip components, can be entirely designed for single use. This design not only simplifies user operation but also eliminates cumbersome cleaning and maintenance steps required in traditional atomizers. The single-use atomizing core prevents clogging issues that arise from long-term use and need for replacement, thus improving convenience and hygiene. Meanwhile, the disposable structure ensures that each use involves new, uncontaminated components, thereby enhancing usage safety and reliability.

### BRIEF DESCRIPTION OF THE DRAWINGS

FIG. 1 shows a perspective view of a disposable liquid container for an atomizing device according to an embodiment of the present disclosure;

FIG. 2 shows an exploded view of FIG. 1;

FIG. 3 shows a perspective view of a first component of the disposable liquid container in FIG. 1;

FIG. 4 shows a perspective view of a second component of the disposable liquid container in FIG. 1;

FIG. 5 shows a front view of FIG. 1 and a A-A sectional view thereof;

FIG. 6 shows an enlarged view of detail I in FIG. 5;

FIG. 7 shows an example of a blocking strip being pulled out;

FIG. 8 shows changes of a sealing member with the blocking strip removed;

FIG. 9 shows a top view of FIG. 1 and a B-B sectional view thereof;

FIG. 10 shows an enlarged view of detail II in FIG. 9;

FIG. 11 shows a perspective view of a disposable liquid container for an atomizing device according to another Embodiment 2 of the present disclosure;

FIG. 12 shows an exploded view of FIG. 11;

FIG. 13 shows a perspective view of a second component of the disposable liquid container in FIG. 11;

FIG. 14 shows a perspective view of a first component of the disposable liquid container in FIG. 1;

FIG. 15 shows a top view of FIG. 11 and a C-C sectional view thereof;

FIG. 16 shows a partial enlarged view of FIG. 15;

FIG. 17 shows an example of a blocking strip being pulled out; and

FIG. 18 shows changes of a sealing member with the blocking strip removed.

Reference Signs: 1 container, 11 opening, 2 atomizing assembly, 3 blocking strip, 4 slot, 20 spray outlet, 21 air inlet, 22 atomizing core, 311 air inlet channel, 312 air outlet channel, 321 liquid supply channel, 322 liquid return channel, 23 first component, 24second component, 231 first cavity, 241 second cavity, 232 first outer flange, 233 inner body, 242 second outer flange, 5 sealing member, 51 first sealing element, 52 second sealing element, 53 third sealing element, 54 fourth sealing element, 6 sealing ring.

### DETAILED DESCRIPTION OF THE EMBODIMENTS

The drawings of the present disclosure are for illustrative purposes only and should not be construed as limiting the present disclosure. For better explanation of the following embodiments, certain components in the drawings may be omitted, enlarged, or reduced, and do not represent actual product dimensions. For those skilled in the art, certain well-known structures and their descriptions may be omitted for clarity.

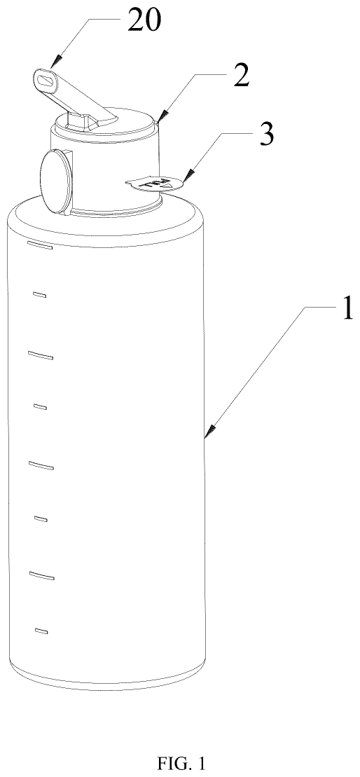

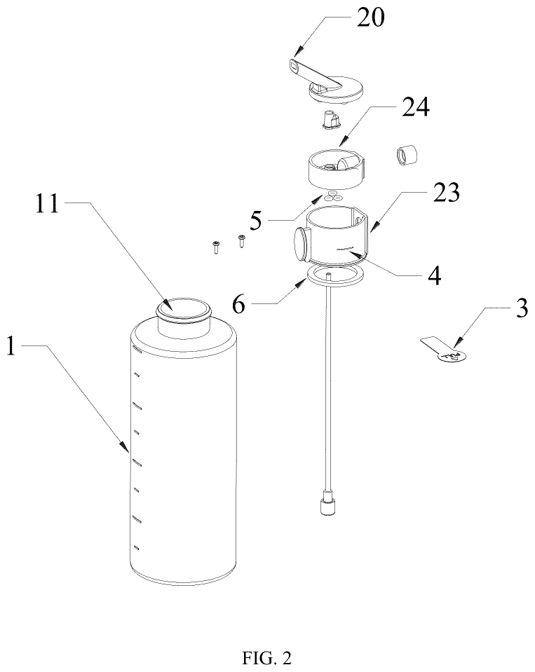

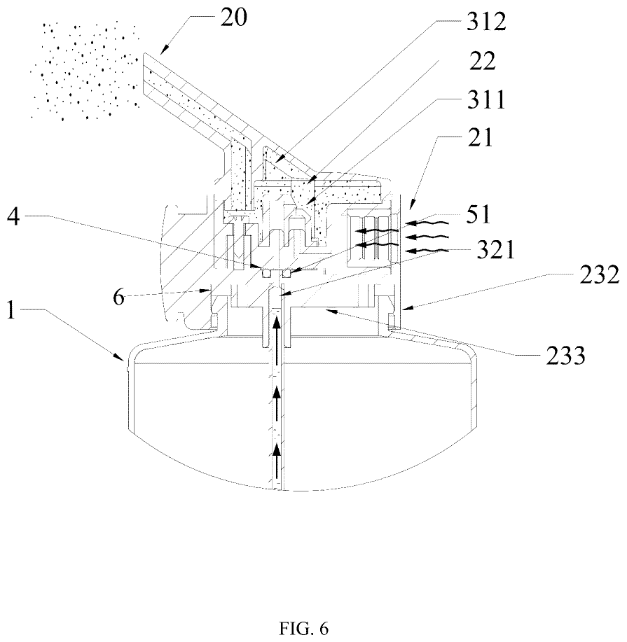

FIGS. 1 and 2 depict a disposable liquid container for an atomizing device according to an embodiment of the present disclosure, which prevents liquid leakage by blocking the liquid channel with a blocking strip. The disposable liquid container in this embodiment includes a cylindrical container 1 with a circular opening 11 for holding liquid, an atomizing assembly 2 covered the circular opening 11 of the container 1, and a blocking strip 3. The container and opening shapes can be flexibly adjusted and customized according to actual application scenarios or specific requirements in this embodiment. The atomizing assembly 2 has a spray outlet 20, air inlet 21, and atomizing core 22 (shown in FIG. 6). The atomizing assembly 2 has internal fluid channels for air or liquid flow. The spray outlet 20 is formed on a spray tube which is detachably and obliquely installed on top of the atomizing assembly 2. The shape of the spray outlet 20 can be adjusted according to requirements, such as circular, oval, or ovaloid shape. The air inlet 21 is annular and designed to connect with an external high-pressure air delivery equipment such as compressors or air pumps. The air inlet 21 preferably has an internal rubber component with protruding strips to enhance sealing with the external high-pressure air delivery equipment.

The atomizing assembly 2 has a detachable design, which can be divided into a first component 23 and a second component 24. These two components are secured together with screws or other common fasteners. A slot 4 between the two components is formed for receiving the blocking strip 3, which traverses the fluid channels, namely perpendicular to the fluid channels. The dimension of slot 4 substantially match that of the blocking strip 3. When the device is out of use, the blocking strip 3 is positioned within the slot 4 to block the fluid channel while partially extending outside of slot 4. The portion of the blocking strip 3 within the slot 4 matches the length, width and thickness of the slot 4, while the external portion is designed into a circular shape, which increases the surface area for easier grip to pull it out by users. Additionally, exterior of the blocking strip 3 may include markings to guide proper usage. When the blocking strip 3 is pulled out from the slot 4, fluid channel communication is restored.

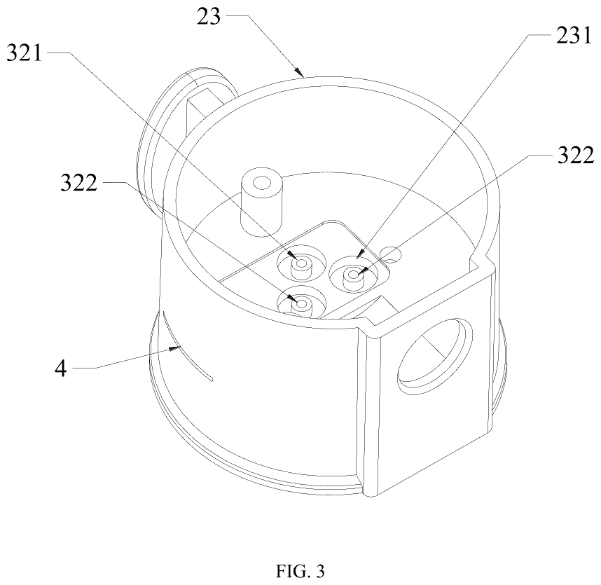

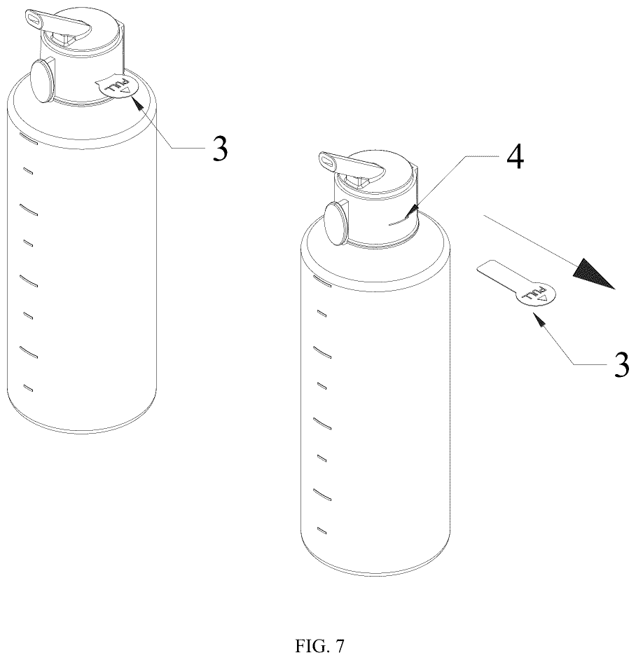

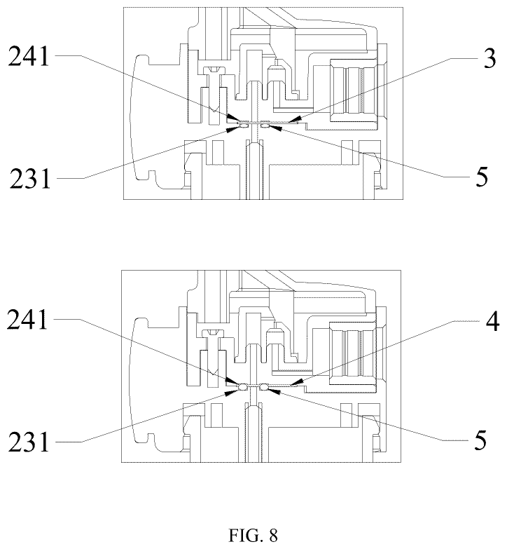

A sealing member 5 is further included, consisting of an elastic sealing ring with a circular cross-section. The first component 23 is positioned between the second component 24 and container 1. The sealing member 5 surrounding the fluid channel is positioned between the first component 23 and blocking strip 3. Referring now to FIG. 3, a first cavity 231 for accommodating the elastic sealing ring is formed within the first component 23 at a position corresponding to one side of the fluid channel. The depth of the first cavity 231 is preferably less than the cross-sectional dimension of the elastic sealing ring. A second cavity 241 (shown in FIG. 8) corresponding to the first cavity 231 is formed within the second component 24 at a position corresponding to another side of the fluid channel. The cross-sectional shape of the cavities can be arc-shaped or square, among others. In addition, the second cavity 241 is shallower than the first cavity 231. As shown in FIGS. 7 and 8, before removed, the sealing member 5 is compressed by the blocking strip 3 to deform the cross-section to an oval shape. When the blocking strip 3 is removed, the sealing ring, due to its elastic properties, returns to its circular cross-section, so as to expand and thus block the slot 4.

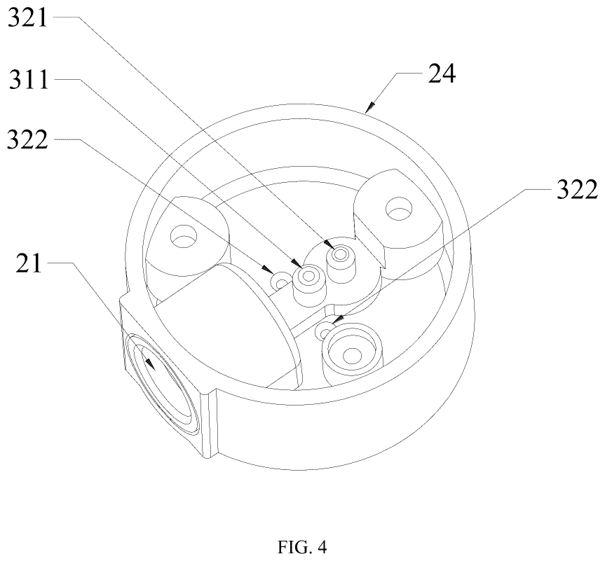

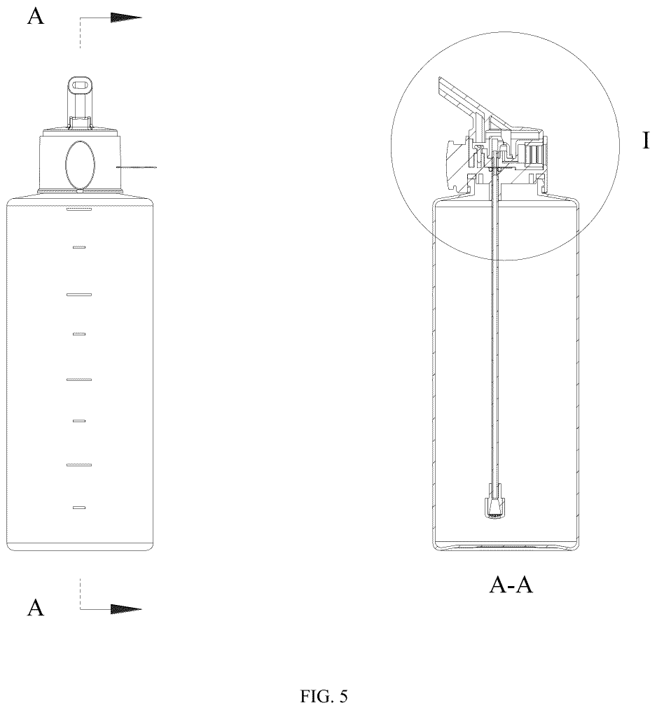

The fluid channel specifically includes a liquid channel and an air channel. The liquid channel connects the atomizing assembly 2 to the interior of the container 1, while the air channel connects the spray outlet 20 to the air inlet 21. Referring to FIGS. 4 to 6, the liquid channel particularly includes a liquid supply channel 321 and liquid return channel 322. One end of the liquid supply channel 321 extends to the bottom of container 1 for liquid extraction, while the other end connects to the atomizing core 22 (shown in FIG. 6). The liquid return channel 322 is positioned in the first component 23 and second component 24, which is configured for returning unatomized liquid from the atomizing core 22 back into the container 1 to ensure effective liquid circulation and atomization. In this embodiment, the blocking strip 3 can simultaneously block both the liquid supply channel 321 and the liquid return channel 322 to prevent liquid leakage, with the blocking strip 3 positioned between the atomizing core 22 and the container 1, namely the atomizing core 22 and the container 1 are respectively positioned on an upper side and a lower side of the blocking strip 3.

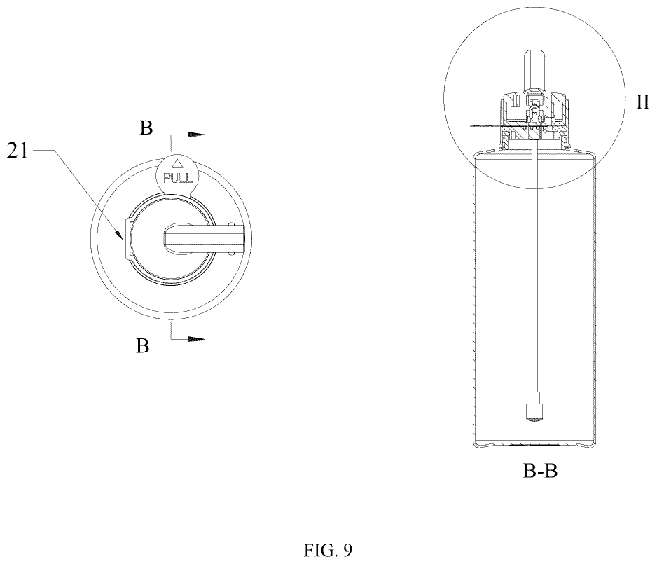

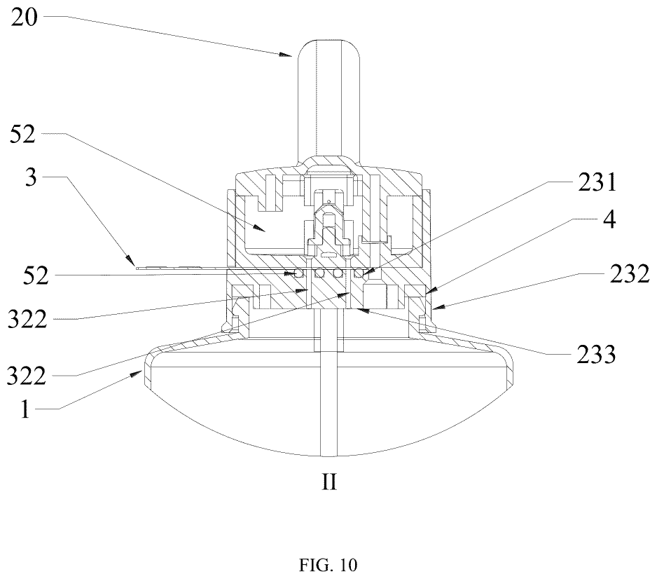

Further in combination with FIG. 9 and FIG. 10, the sealing member 5 specifically includes a first sealing element 51 and a second sealing element 52, with the first sealing element 51 surrounding the liquid supply channel 321 (shown in FIG. 6) and the second sealing element 52 surrounding the liquid return channel 322 (show in FIG. 10), providing dedicated sealing for the liquid supply channel 321 and the liquid return channel 322. In this embodiment, there are one liquid supply channel 321 and two liquid return channels 322, one first sealing element 51 and two second sealing elements 52 are accordingly provided, which respectively correspond to the liquid supply channel 321 and the two liquid return channels 322. Preferably, a connecting member is further provided to join the first sealing element 51 and the second sealing elements 52 into an integral structure, which enables simultaneous installation of both sealing elements during production assembly, eliminating the need for separate installation procedures.

To prevent liquid leakage at the interface between the container 1 and the atomizing assembly 2 during transportation or use, the atomizing assembly 2 and the container 1 are fixedly connected into an inseparable integral structure. This design also ensures that the container 1 cannot be disassembled and refilled after the liquid is exhausted, achieving true single-use functionality and thus avoiding hygiene issues and performance degradation associated with reuse.

As shown in FIGS. 6 and 10, the first component 23 particularly includes a first outer flange 232 and an inner body 233. The first outer flange 232 extends to the outside of the opening 11 of the container 1, while the inner body 233 extends to the inside of the opening 11. A first annular groove is formed between the first outer flange 232 and the inner body 233, which is used to contain a sealing ring 6 (shown in FIG. 2). In such configuration, the first outer flange 232 is interlocked with the opening 11 of container 1, creating a sealing layer structure between the container 1 and the atomizing assembly 2. Assembly simply requires aligning the first outer flange 232 with the opening of container 1 and applying gentle downward pressure to achieve secure connection, enhancing overall sealing performance, while simplifying the assembly process and improving production efficiency.

According this embodiment, when the blocking strip 3 is pulled out from the slot 4, air delivered through the air inlet 21 enters the atomizing core 22 via the air inlet channel 311. Simultaneously, the liquid supply channel 321 extracts liquid from the container 1 into the atomizing core 22. Within the atomizing core 22 of the atomizing assembly 2, the air and liquid mix to form atomized liquid particles, such atomized liquid particles then travel through the air outlet channel 312 into the spray outlet 20 for final spray or use.

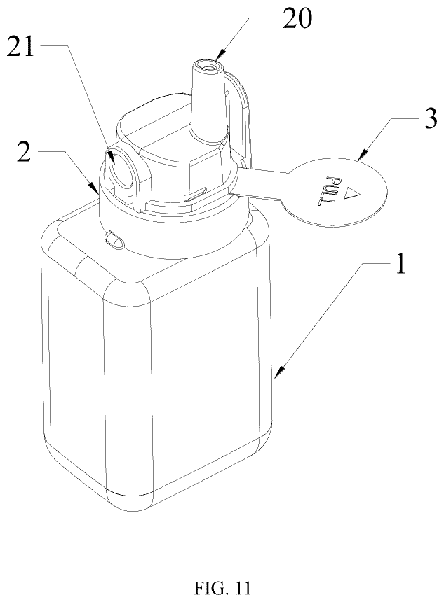

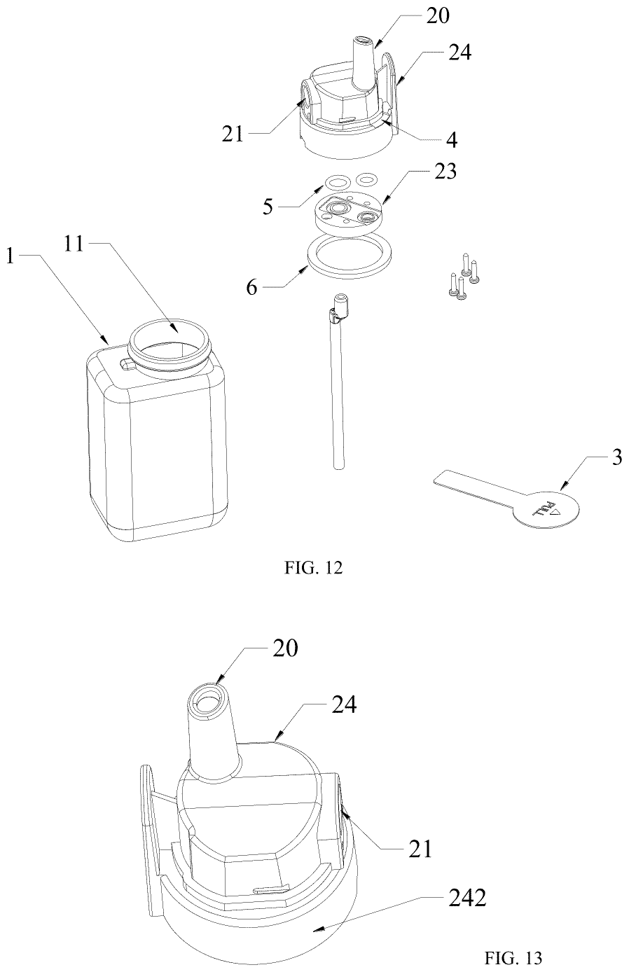

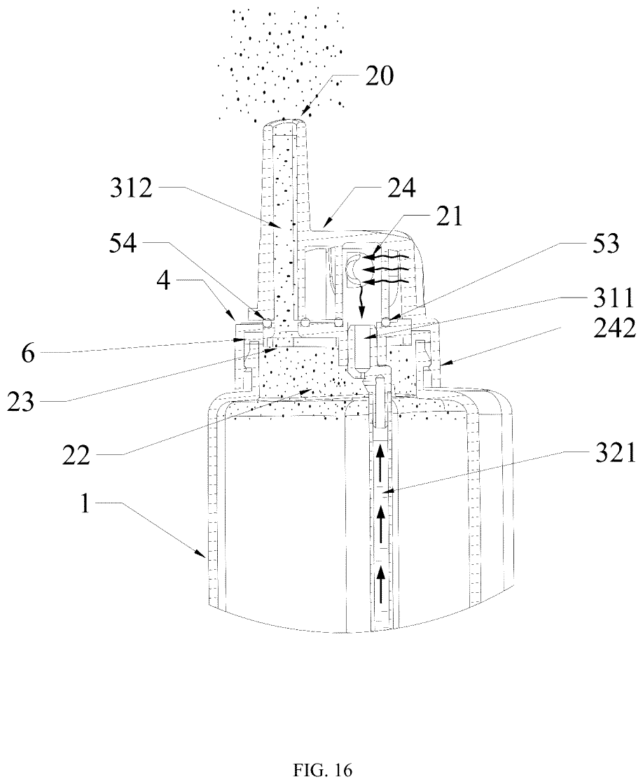

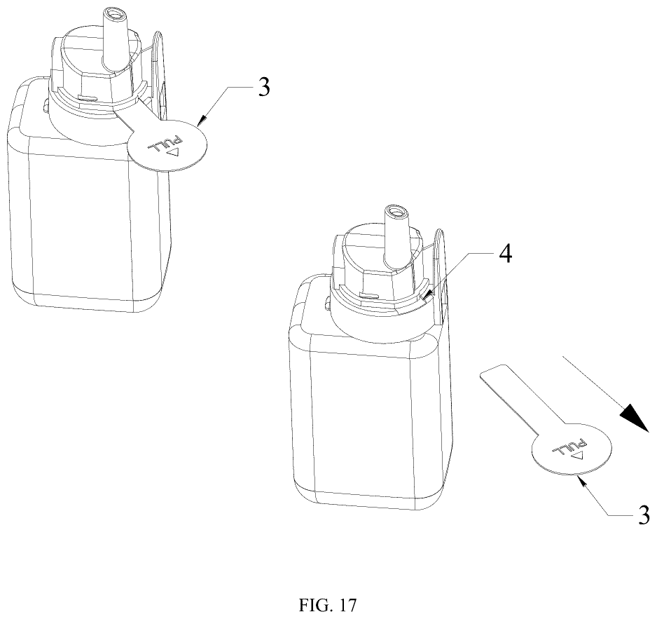

FIGS. 11 and 12 depicts another disposable liquid container for an atomizing device according to another embodiment of the present disclosure, which prevents liquid leakage by blocking the air channel with a blocking strip. The disposable liquid container in this embodiment includes a cuboid container 1 for holding liquid with a circular opening 11, an atomizing assembly 2 covered the circular opening 11 of container 1, and a blocking strip 3. The atomizing assembly 2 has a spray outlet 20, an air inlet 21, and an atomizing core 22 (shown in FIG. 16). The atomizing assembly 2 has internal fluid channels for air or liquid flow. The spray outlet 20 formed on a spray tube which is, which is integrally and vertically formed on one side of the top of the atomizing assembly 2. The shape of the spray outlet 20 can be adjusted according to requirements, such as circular, oval, or ovaloid shape. The air inlet 21 is annular, facilitating connection with an external high-pressure air delivery equipment such as compressors or air pumps.

The atomizing assembly 2 has a detachable design, which can be divided into a first component 23 and a second component 24. These two components are secured together with screws or other common fasteners. A slot 4 is formed between the two components for receiving the blocking strip 3, which traverses the fluid channels, namely perpendicular to the fluid channels. The dimension of the slot 4 substantially match that of the blocking strip 3. The blocking strip 3 is positioned within the slot 4 to block the fluid channel while partially extending outside of the slot 4. The portion of the blocking strip 3 within the slot 4 matches the length, width and thickness of the slot 4, while the external portion outside the slot 4 is designed into a circular shape, which increases the surface area for easier grip to pull it out by users. Additionally, exterior of the blocking strip 3 may include markings to guide proper usage. When the blocking strip 3 is pulled out from the slot 4, fluid channel communication is restored.

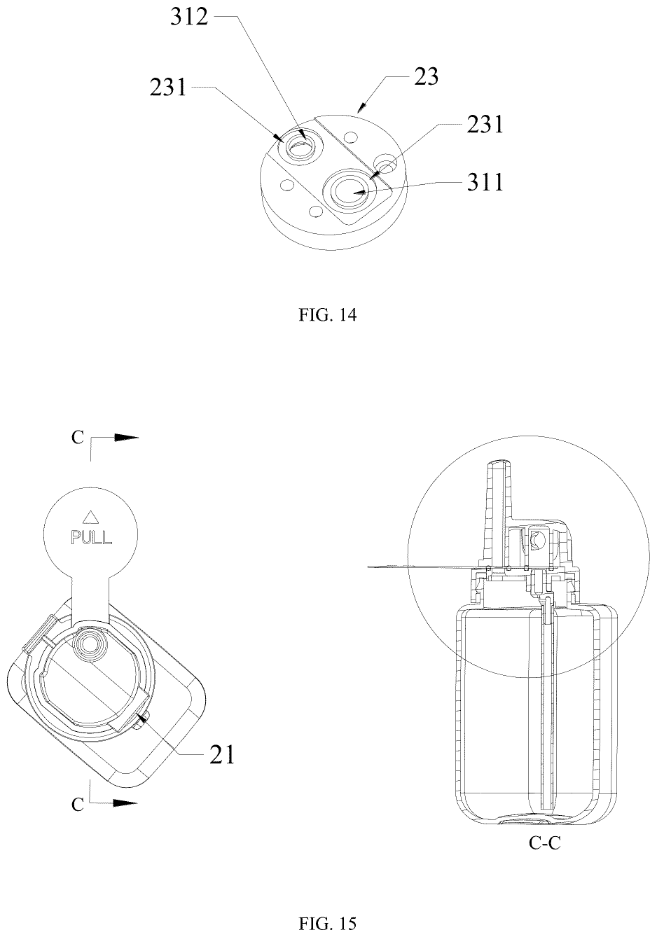

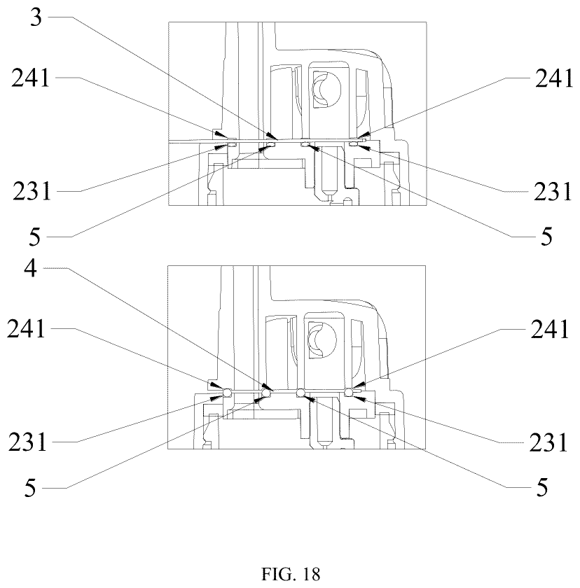

A sealing member 5 is further included, consisting of an elastic sealing ring with a circular cross-section. The first component 23 is positioned between the second component 24 and the container 1, with the sealing member 5 positioned between the first component 23 and the blocking strip 3 and surrounding the fluid channel. Referring now to FIG. 14, a first cavity 231 for accommodating the elastic sealing ring is formed within the first component 23 at a position corresponding to one side of the fluid channel. The depth of the first cavity 231 is preferably less than the cross-sectional dimension of the elastic sealing ring. A second cavity 241 (shown in FIG. 18) corresponding to the first cavity 231 is formed within the second component 24 at a position corresponding to another side of the fluid channel, with the second cavity 241. The cross-sectional shape of the cavities can be arc-shaped or square. In addition, the second cavity 241 is shallower than the first cavity 231. As shown in FIGS. 17 and 18, before removed, the blocking strip 3 presses the sealing member 5 to deform its cross-section to an oval shape. When the blocking strip 3 is removed, the sealing ring, due to its elastic properties, loses the compression exerted by the blocking strip 3, and returns to its circular cross-section, so as to expand and thus block the slot 4.

The fluid channel specifically includes a liquid and an air channel, with the liquid channel connecting the atomizing assembly 2 to the interior of the container 1, and the air channel connecting the spray outlet 20 to the air inlet 21. Referring to FIGS. 14 to 16, the air channel particularly includes an air inlet channel 311 and an air outlet channel 312. One end of the air inlet channel 311 connects to the air inlet 21, while the other end connects to the atomizing core 22 within the container 1. One end of the air outlet channel 312 connects to the spray outlet 20 and the other end connects to the atomizing core 22 within the container 1. In this embodiment, the blocking strip 3 can simultaneously block both the air inlet channel 311 and the air outlet channel 312 to prevent leakage, with both the atomizing core 22 and the container 1 positioned on the lower side of the blocking strip 3.

As shown in FIG. 16, the sealing member 5 specifically includes a third sealing element 53 and a fourth sealing element 54, with the third sealing element 53 surrounding the air inlet channel 311 and the fourth sealing element 54 surrounding the air outlet channel 312, which provide dedicated sealing for the air inlet channel 311 and the air outlet channel 312 respectively. In this embodiment, there is one air inlet channel 311 and one air outlet channel 312, one third sealing element 53 and one fourth sealing element 54 are accordingly provided, which correspond to the air inlet channel 311 and the air outlet channel 312 respectively. Preferably, a connecting member is further provided to join the third sealing element 53 and the fourth sealing element 54 into an integral structure, which enables simultaneous installation of the two sealing members 5 during production assembly, eliminating the need for separate installation procedures.

To prevent liquid leakage at the interface between the container 1 and the atomizing assembly 2 during transportation or use, the atomizing assembly 2 and the container 1 are fixedly connected into an inseparable integral structure. This design also ensures that the container 1 cannot be disassembled and refilled after the liquid is exhausted, achieving true single-use functionality and thus avoiding hygiene issues and performance degradation associated with reuse.

As shown in FIG. 16, the second component 24 particularly includes a second outer flange 242 extending to the outside of the opening 11, with the first component 23 embedded into the second outer flange 242. A second annular groove cooperated with the opening 11 of container 1 is formed between the second outer flange 242 and the first component 23. A sealing ring 6 is provided within the second annular groove. In such configuration, the second outer flange 242 is interlocked with the opening 11 of container 1, creating an alternative sealing layer structure between the container 1 and the atomizing assembly 2. Assembly simply requires aligning the second outer flange 242 with the opening 11 of container 1 and applying gentle downward pressure to achieve secure connection, enhancing overall sealing performance, while simplifying the assembly process and improving production efficiency.

According this embodiment, when the blocking strip 3 is pulled out from the slot 4, air delivered through the air inlet 21 enters the atomizing core 22 via the air inlet channel 311. Simultaneously, the liquid supply channel 321 draws liquid from the container 1 into the atomizing core 22. Within the atomizing core 22 in the container 1, air and liquid mix to form atomized liquid particles, such atomized liquid particles then travel through the air outlet channel 312 into the spray outlet 20 for final spray or use.

Obviously, the aforementioned embodiments of the present disclosure are provided merely to clearly illustrate the technical solutions and should not be construed as limiting the specific implementation methods of the present disclosure. Any modifications, equivalent substitutions, and improvements made within the spirit and principles of the claims of the present disclosure shall fall within the protection scope thereof.

What is claimed is:

1. A disposable liquid container for an atomizing device, comprising:
a container for holding liquid, the container having an opening;
an atomizing assembly covered the opening, the atomizing assembly having a spray outlet, an air inlet, and an atomizing core, an internal fluid channel for air or liquid flow being inside the atomizing assembly; and
a blocking strip which is operable to block the fluid channel,
wherein the atomizing assembly is provided with a slot traversing the fluid channel, the blocking strip is configurated to block communication of the fluid channel, with disposed in the slot and partially extending outside the slot, and unblock communication of the fluid channel, with removed from the slot to restore communication of the fluid channel.

2. The disposable liquid container according to claim 1, wherein the atomizing assembly comprises a first component and a second component that are cooperated with each other, and the slot is formed between the first component and the second component.

3. The disposable liquid container according to claim 2, wherein a sealing member surrounding the fluid channel is provided between at least one of the first component and the second component and the blocking strip at a position corresponding to the fluid channel.

4. The disposable liquid container according to claim 3, wherein the first component is positioned between the container and the second component, and the sealing member is positioned between the first component and the blocking strip.

5. The disposable liquid container according to claim 3, wherein the sealing member is in form of an elastic sealing ring, a first cavity is formed in at least one of the first component or the second component corresponding to one side of the fluid channel, with a depth of the first cavity being less than a cross-sectional dimension of the elastic sealing ring, and the elastic sealing ring is compressed within the first cavity when the blocking strip is disposed in the slot.

6. The disposable liquid container according to claim 5, wherein a second cavity corresponding to the first cavity is formed in at least one of the second component and the first component at a position corresponding to another side of the fluid channel, which is configured for accommodating the elastic sealing ring expanded when the blocking strip is removed from the slot.

7. The disposable liquid container according to claim 3, wherein the fluid channel comprises an air channel connecting the spray outlet to the air inlet, and a liquid channel connecting the atomizing assembly to an interior of the container.

8. The disposable liquid container according to claim 7, wherein the atomizing core and the container are respectively positioned on an upper side and a lower side of the slot, wherein the liquid channel comprises a liquid supply channel for guiding liquid upward from the container to the atomizing core and at least one liquid return channel for returning liquid unatomized downward to the container, and wherein the blocking strip is configured to simultaneously block both the liquid supply channel and the liquid return channel when the blocking strip is disposed in the slot.

9. The disposable liquid container according to claim 8, wherein the sealing member comprises two sealing elements, with one surrounding the liquid supply channel and the other one surrounding the liquid return channel, and a connecting member which joins the two sealing elements into an integral structure.

10. The disposable liquid container according to claim 7, wherein the atomizing core and the container are both positioned below the slot, wherein the air channel comprises an air inlet channel connecting the atomizing core to the air inlet and an air outlet channel connecting the atomizing core to the spray outlet, and wherein the blocking strip is configured to simultaneously block both the air inlet channel and the air outlet channel when the blocking strip is disposed in the slot.

11. The disposable liquid container according to claim 10, wherein the sealing member comprises two sealing elements, with one surrounding the air inlet channel and the other one surrounding the air outlet channel, and a connecting member which joins the two sealing elements into an integral structure.

12. The disposable liquid container according to claim 1, wherein the atomizing assembly and the container are fixedly connected into an inseparable integral structure.

13. The disposable liquid container according to claim 4, wherein the first component comprises an outer flange extending to an outside of the opening of the container and an inner body extending to an inside of the opening of the container, wherein an annular groove cooperated with the opening is formed between the outer flange and the inner body, a sealing ring is provided within the first annular groove, and the outer flange is interlocked with the opening.

14. The disposable liquid container according to claim 4, wherein the second component comprises an outer flange extending to an outside of the opening of the container, wherein the first component is embedded into the second outer flange, wherein a second annular groove cooperated with the opening is formed between the second outer flange and the first component, a sealing ring is provided within the second annular groove, and the second outer flange is interlocked with the opening.
